(19) United States
(12) Patent Application Publication
(10) Pub. No.: US 2007/0100825 A1
(43) Pub. Date: May 3, 2007

(54) Process for sorting large lists on a 64-bit computing platform

(76) Inventors: Russell W. Guenthner, Glendale, AZ (US); Clinton B. Eckard, McMinnville, TN (US); David A. Bird, Phoenix, AZ (US); John E. Heath, Glendale, AZ (US)

Correspondence Address: Dr. Russell W. Guenthner;Bull HN Information Systems Inc., MS B55, 13430 N. Black Canyon Highway, Phoenix, AZ, 85029, US

(21) Appl. No.: 11/267,784

(22) Filed: Nov. 1, 2005

(51) Int. Cl. G06F 7/00

(52) U.S. Cl. 707/7

(57) ABSTRACT

A process for sorting large files or structures is disclosed where improved performance is achieved by reducing the work involved and the time required to do record key comparisons. The reduction is achieved by transposing and saving the key data from each record into a representative form that can be more quickly compared each time the key comparison is required. In addition the process uses pointers to avoid the processing time to exchange records larger than one word in memory. The representation of the key data is optimized and aligned for comparison by word based computer instructions which are typically faster than byte based instructions. The process is optimized for word sizes and instructions which handle words larger than four bytes and in particular for machines and instructions with 64-bit or larger word sizes such as the Intel Itanium series processors.

### FIELD OF THE INVENTION

This invention relates to the art of computer system programming and, more particularly, the design of algorithms and processes for sorting large arrays, lists, files and other representations of computer system data. Sorting is based upon transformation of data to be sorted into representative keys in a form suited for improved speed of processing on a 64-bit computing platform such as the Intel 64-bit Itanium series CPUs. A well known improved version of Quicksort and the Mergesort algorithms may be used as part of the procedure. The subject process utilizes in-memory sorting and if necessary intermediate files for temporary storage followed by a merge of data from the intermediate files into a final sorted output file. The process also can be applied directly to sorting large arrays of data contained in memory without the intermediate and merge file activity.

### BACKGROUND OF THE INVENTION

Current state-of-the-art algorithms for sorting typically are structured such that the sorting of a large file containing large numbers of records is achieved by reading some number of records into memory, sorting the records, and then writing those records out to an intermediate file. The procedure is repeated until the entire input file has been read and split into smaller intermediate sorted files, and then the smaller files are collectively read and merged into a final sorted output file. For very large amounts of data or large numbers of files the merging of the intermediate files may require more than one pass. The sorting of the data in memory is a significant part of the overall work to be done and the choice of method for accomplishing the in-memory sort is critical to overall performance of the sorting procedure.

There are many well known algorithms for in-memory sorting and all which are useful on large problems are of overall complexity of at least O(n log n) (read “order” n log n). The algorithms require two data records to be compared a number O(n log n), and also O(n log n) exchanges of the two data records. Since a number O(n log n) is larger than n, this means that the time to sort a large number of records increases at a rate faster than the number of records, and therefore, with large numbers of records, the time to sort grows in proportion faster than the number of records. The time required to perform comparisons between two keys and the time to exchange data records in a data structure are thus major contributors to the overall processing time for accomplishing the sort, and any significant reduction in the time of comparison or time for data exchange will result in much better overall sort performance as the number of data records being sorted becomes large.

In approaching a sort problem it is important to note also that preprocessing of the input data is a procedure that requires time which is approximately directly proportional to the number of input records, that is time O(n). That is, doing work of any kind on the input data will be of complexity O(n) as long as each input data record is processed individually without knowledge of other records. Therefore, if preprocessing can be utilized to reduce the time for comparison of records in the actual sort, which is time O(n log n), then there will be an overall benefit as the number of records n becomes large. Similarly if preprocessing provides for reducing the time or work for exchanging data records it will also be a good overall benefit as the number of items to be sorted is large or approaches infinity.

A sorting process requires utilizing the user's specification of which fields of the input data are the key data and also determining the user's requirements on the desired sort order and significance of the data in the key. For example, in GCOS8 COBOL 85 the sort verb is described in the Bull HN COBOL 85 Reference Manual DS52-10 as follows.

The SORT statement creates a sort file by executing an input procedure or by transferring records from another file; sorts the records in the sort file using a set of specified keys, and, in the final phase of the sort operation, makes available each record from the sort file, in sorted order, to an output procedure or to an output file.

General Format of Sort Command:

```
SORT file{ON{ASCENDING | DESCENDING}KEY{data-name-1}...}...
    [WITH DUPLICATES IN ORDER] ...
    [COLLATING SEQUENCE IS alphabet-name-1]
    {INPUT PROCEDURE IS procedure-name-1 ... }
    {OUTPUT PROCEDURE IS procedure-name-3 ... }
```

Note that the phrase
“{ON{ASCENDING|DESCENDING}KEY{data-name-1} . . . }”
allows the key data to be specified as the concatenation of a number of data elements or substructures of a record, and the elements can be specified to be used in ASCENDING or DESCENDING order.

In GCOS8 COBOL 85 the comparison that is required to compare two records containing key data described in the manner above is accomplished by the compiler generating a routine of assembly (machine) instructions to examine the data in the specified manner to accomplish the desired comparison. In the current art, this comparison routine would be repeatedly called whenever the comparison of two key elements is required, and the comparison would signal a result of “<”, “=” or “>” depending on the data contained in the specified two key elements. This signal would then be used to determine whether an exchange of two records is desired as part of the sorting process. This comparison would happen O(n log n) times, which as n approaches infinity grows faster than n itself. So the time required to make the comparison is a very important contributor to the performance of the overall sort. It is thus desirable to reduce the time for the comparison between any two data records. It is also desirable to avoid an exchange of data records in memory, and to develop a process for sorting that allows and provides for an exchange of pointers to the data records, not the exchange of the data records or keys themselves.

### OBJECTS OF THE INVENTION

It is therefore a broad object of this invention to improve performance of a software program for sorting of data by combining several elements of improvement to typical sort procedures with the design and selection of the proper combination of such improvements being with specific regard to those which when combined will provide for much faster overall processing on a processor of 64-bits or larger. Adding work in the preprocessing stage of the sort process which is of O(n) will be of preference if that preprocessing work can reduce the time in the actual sort part of the process which is O(n log n). The implementation of the process on a machine with 64 or more bits in a machine word can result in a large improvement in overall performance, especially as the number of records to be sorted grows large.

The approach for moving work from the main sorting steps back to the preprocessing procedure is to align and transform the input data records into representative keys which can be compared and exchanged by machine instructions operating on whole 64-bit or larger words. This avoids the use of more inefficient bit or character based machine operations, and allows a larger piece of data to be handled by each machine instruction. The program or machine loops that are required for manipulating whole words of data are also more efficient than loops which operate on character or bit size data.

It is important to note that selection of sort algorithms for a machine with word sizes significantly smaller than 64 bits, such as 32-bits would not typically provide the degree of improvement observed for larger word sizes, and the selection of processing steps would not be the same.

### SUMMARY OF THE INVENTION

Briefly, these and other objects of the invention are achieved by the design of a novel process for sorting data records which is intended most specifically for a 64-bit or larger computing platform. Utilizing and manipulating representations of the data records in the sort process which have been preprocessed to be in a form most readily manipulated by a 64-bit processor such as the Intel Itanium 2 provides for an improvement in overall performance. The sort process of the invention organizes representative key data on machine word boundaries, eliminates the exchange of long data records during sorting and manipulates tables of pointers to key data which represent the input data records using pointers to the keys instead of actually moving data or key records themselves.

As already described, the first improvement is providing a process to allow for faster comparison of data records by choosing a method which utilizes 64-bit word based comparisons. A second improvement is to provide a sorting process which allows for avoiding the exchange of the actual data records in memory or within a file by exchanging 64-bit pointers to representative key records instead of exchanging the data or the keys themselves. Machine words of size 64-bits are large enough to allow single words to point to a data space for sorting which is larger than the actual memory size of any computer in existence today. A third improvement is to increase the performance of the key data comparison by aligning all representative key data on 64-bit word boundaries and a fourth improvement is stopping the comparison of the key data immediately when any difference is found, rather than continuing to the end of the record. A fifth improvement is to preprocess the data records and transform them to a form such that the representative data comparison can be done as a continuous series of 64-bit word comparisons. This transformation means in effect that all data for comparison is represented as a string of unsigned numbers, typically binary. Combining such improvements to a sort process provides a process for sorting that can be an order of magnitude faster than processes of the prior which are provided as a part of typical operating systems of today such as Linux and which have migrated from a world of computing that utilized smaller word sizes or which did not select or combine the improvements described above.

Any typical sorting mechanism must provide for controlling the sorting process and describing the input data in the manner as typically described in the COBOL computing language with a phrase describing the input data and specifying the desired result of the sort such as:
“{ON{ASCENDING|DESCENDING}KEY{data-name-1} . . . }”
with each field described in this exemplary manner.

As the data is first read from the input file by a preprocessing routine it is stored in a representative form that can be quickly examined by a comparison routine. The sorting process of the invention constructs a representative form of the data which is aligned on full word boundaries and which can be compared quickly using full word integer comparisons between any two of the data items in that representative form. The data of the key might be described such that the data consists of (A) 10 ASCII characters in ASCENDING order, followed by (B) six binary words of data, and then (C) a decimal numeric item of the form XXXXX.XX. In addition, items (A), (B), and (C) could be specified in any order such that (B) takes significance over (A), or the order of significance could be specified as (C), (B), (A). The routine takes the data type specification and also the sort order specification, and then applies these to each record as it is read from the input file. It then stores in memory, as a representative key, a string of bits representing the data such that a comparison of that string of bits as an unsigned comparison of two values will provide the same result as comparing the two original keys with the same order of specification.

This string of bits described representing the data items is the “representative key data”, with the data of the key ordered from most significant to least significant. It is of further advantage to start and end the string of representative bits on machine word boundaries so that the comparison of any bit string longer than a single word can be performed as a series of word comparisons. By arranging the words for comparison in order of significance with most significant words being processed first, a further optimization is to stop the comparison of the bit strings or words as soon as any of the two words being compared are different. This may decrease the time for performing the comparison. The key data when representing a data item as a string of bits must use an unsigned number format for the representative string in order that the concatenation of multiple representative strings for a series of data items results in a single unsigned string that can be compared as a whole without regard to data item boundaries, that is, by a series of word comparisons.

Formation of the representative key data requires further consideration as to the effect of the ASCENDING or DESCENDING clause. If any of the fields is specified as “DESCENDING”, as opposed to ASCENDING, then the string of bits stored as representing that portion of the input data record must be negated in one's complement form so that the simple unsigned comparison of the two values will result in the opposite of that which would have resulted if the specification were ASCENDING. This allows the comparison to occur quickly without having to distinguish during the comparison whether the original specification was ASCENDING or DESCENDING. The work which must be done to differentiate between ASCENDING or DESCENDING and other similar work related to the data description and sort order must all be done during the input data processing, and not delayed or repeatedly done during the comparison operation of the actual sort processing.

As an example of more complex input data, for decimal numeric data that has only a scale factor and no exponent, the numeric data can be packed into 4-bit fields with 16 digits per 64-bit word, and the scale factor can be disregarded because it is the same in both of the records to be compared. For decimal data, the representation must also provide transformation for handling ASCENDING and DESCENDING by complementing the data if descending.

For decimal numeric data with an exponent, or floating point data with an exponent, the data can be either transformed into a binary value which will hold the entire possible significance of the input data, or a special flag on the key must be maintained which causes the comparison routine to change its method of comparison for certain ranges of the key.

Another alternative is to store any floating point number in “normalized” form. This method of storage results in a mantissa being in a fixed range of values such that the exponents can be used as a higher order comparison, and the mantissa as a second order comparison only if the exponents are equal. This allows floating point data to be compared in a manner compatible with the word based algorithm described above.

Other forms of data which are input to the sort process must be transformed in a manner similar to those described above such that the resulting representative data key is an unsigned string and also such that the comparison of any two of the representative data keys will result in the same result as though the original data items were compared. Algorithms or processes for performing such a transformation will be readily apparent to those skilled in the art.

In general, data of many forms can be transformed into representative key data where a string of bits, or words can represent the data in a manner allowing for fast comparison with results equivalent to that which would be achieved if the original data records were compared. Processing the data for comparison utilizing 64-bit word based instructions is much faster than equivalent comparison of strings of bits or characters. Also, with the characteristic specification of the key data utilizing verbs such as “ascending” or “descending” or “bit” or “float” or other commonly known data types it is greatly advantageous to process the data for comparison only once per record during input processing instead of every time that record is compared to another during the actual sort processing.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a general diagram depicting records of input data to be sorted;

FIG. 2 is a diagram depicting the input data of FIG. 1 now in sorted order as specified by a first key description;

FIG. 3 is a diagram depicting the input data of FIG. 1 now in sorted order as specified by a second key description;

FIG. 4 is a diagram depicting the input data of FIG. 1 with the records being exchanged as part of a sort process;

FIG. 5 is a diagram depicting the input data of FIG. 1 with pointers to the records being exchanged instead of exchanging the data records themselves;

FIG. 6 is a diagram depicting input data records of varying length with representative keys used for comparison and exchange during the actual sort;

FIG. 7 is a diagram showing the transformation of signed numbers in two's complement form to unsigned strings of bits which can be directly compared as a part of the representative key for a data record; and

FIG. 8 is a diagram showing the transformation to an unsigned string of bits for floating point numbers with both the exponent and the mantissa expressed in signed two's complement format.

### DESCRIPTION OF THE PREFERRED EMBODIMENT(S)

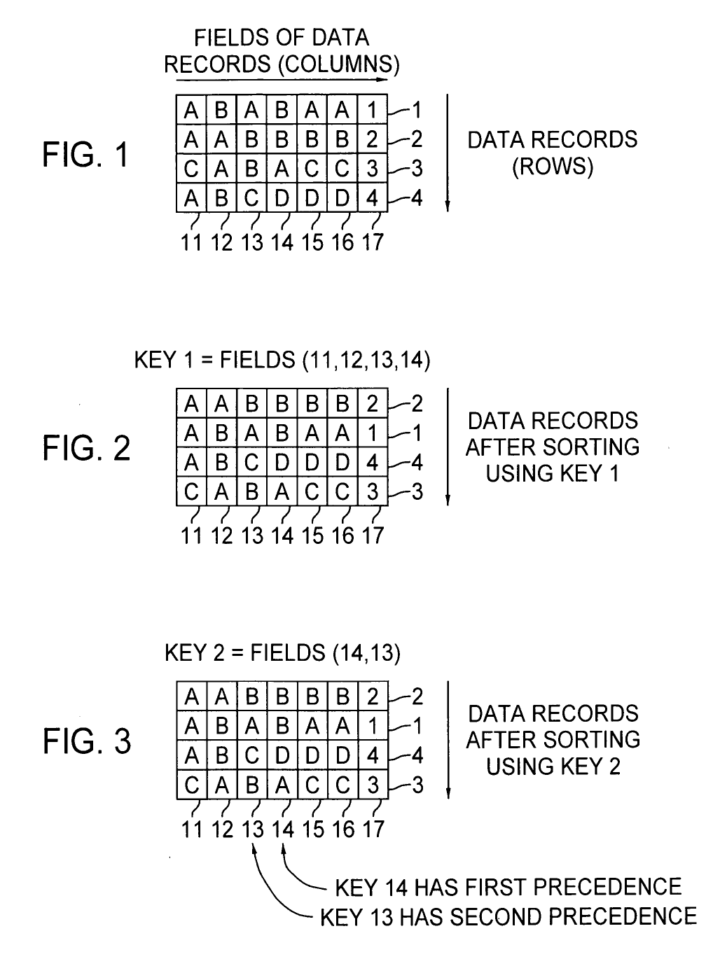

FIG. 1 is a general diagram depicting records of input data to be sorted. Four input data records, labeled 1, 2, 3, and 4, are depicted as “rows” in a matrix and seven columns of characters labeled 11, 12, 13, 14, 15, 16, and 17 are the fields of data making up each record. As the input records are brought into the sort process the “sort key” description describes which fields in the data records are to be considered in the execution of the sort itself. The sort key specification describes which fields are to be considered, the order in which they are to be considered, and also specifies whether each specified field is to be sorted in “ascending” or “descending” order. The higher order fields are most significant in the sort meaning that if two records are compared and these higher order fields are found to be different (one is less than or greater than the other), then the remaining fields need not be considered.

FIG. 2 is a diagram depicting the input data of FIG. 1 now in sorted order as specified by a first sort key description 20 which specifies the first four columns labeled 11, 12, 13, and 14 with the first column 11 most significant and with all fields considered in “ascending” order. In sorted order the records now appear in rows ordered 2, 1, 4, 3 with record 2 starting with “AABB” followed by record 1 starting with “ABAB” followed by record 4 starting with “ABCD” and finally record 3 starting with “CABA”. This is readily recognizable as being in alphabetical order.

FIG. 3 is a diagram depicting the input data of FIG. 1 now in sorted order as specified by a second sort key description 30. Second sort key 30 selects fields in columns 4 and then 3 labeled as 14 and 13. Note that column 4 labeled 13 has higher significance that column 3 labeled 13. With this specification of the sort key, the rows are ordered as labeled 3, 1, 2, and then 4. This is alphabetical considering the fourth column labeled 14 as most significant, and column three labeled 13 as next most significant.

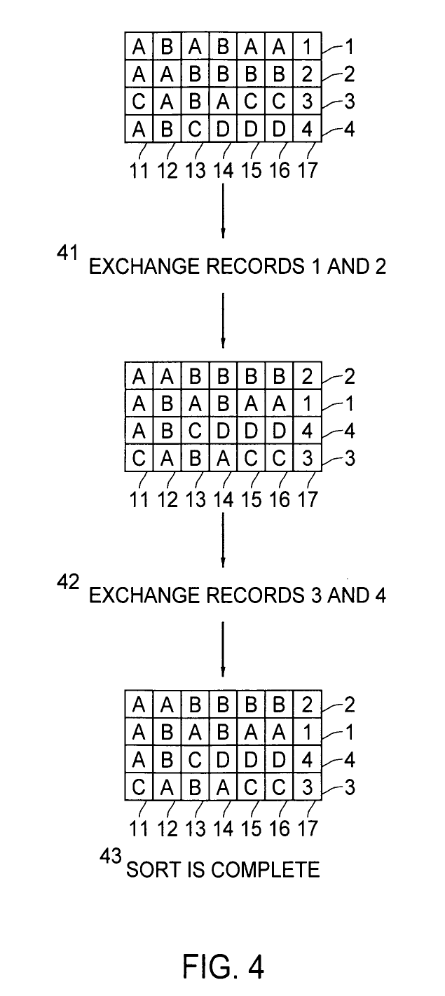

FIG. 4 is a diagram depicting the input data of FIG. 1 with the records being exchanged as part of a sort process. Some type of exchange process is a part of any sort process which handles large amounts of data. The decision to make an exchange or not between any two data records is dependent on the specification of the sort key and a comparison of any two or more data records based upon that sort key specification. If two records are compared and are found to be out of order with respect to the desired sort order, then the two records are “exchanged” meaning that those two records are exchanged so that they are now in the desired sort order. Mathematically this means that if we are sorting in ascending order and two records are compared and the first is greater than the second, then they are exchanged. In FIG. 4 the sorting of the four data records based upon the key 20 from FIG. 2 which specifies the first four columns 11, 12, 13, 14 requires exchanging two pairs of data records. First record 1 is compared with record 2 and found to be out of order so they are exchanged in operation labeled 41. Then, record 3 is compared with record 4 and found to be out of order so they are exchanged by operation 42. The resulting data is now in ascending sorted order with rows in order 2, 1, 4, 3. exactly as first depicted in FIG. 2. When data records, or their key representation is larger than can be contained in one host machine word, then it is a great advantage to not actually exchange whole data records, but instead to construct a table of pointers pointing to the data records and then exchanging the pointers to the data records instead of the data records themselves.

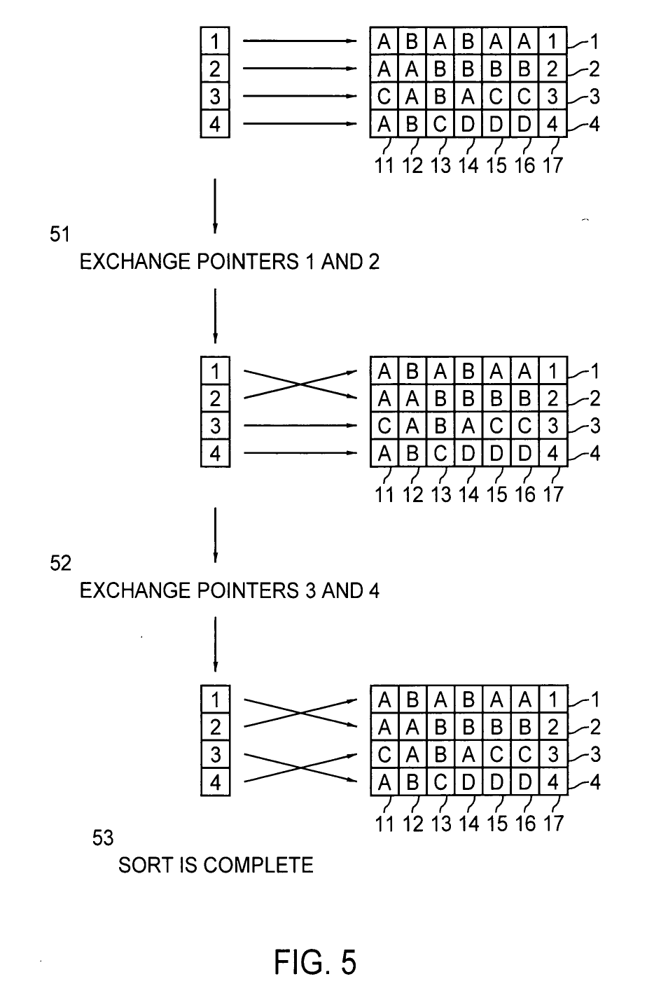

FIG. 5 is a diagram depicting the input data of FIG. 1 with pointers to the records being exchanged instead of exchanging the data records themselves. When the sort is complete, meaning all needed exchanges have been performed, then the order of the pointer table specifies the order in which records can be retrieved and written to an output file. This results in a large time savings compared with moving data records themselves, and is especially useful when the input data records are of varying length such that data records are not easily simply exchanged. This is common when the input data is a file of characters separated into lines where the lines of text vary in length.

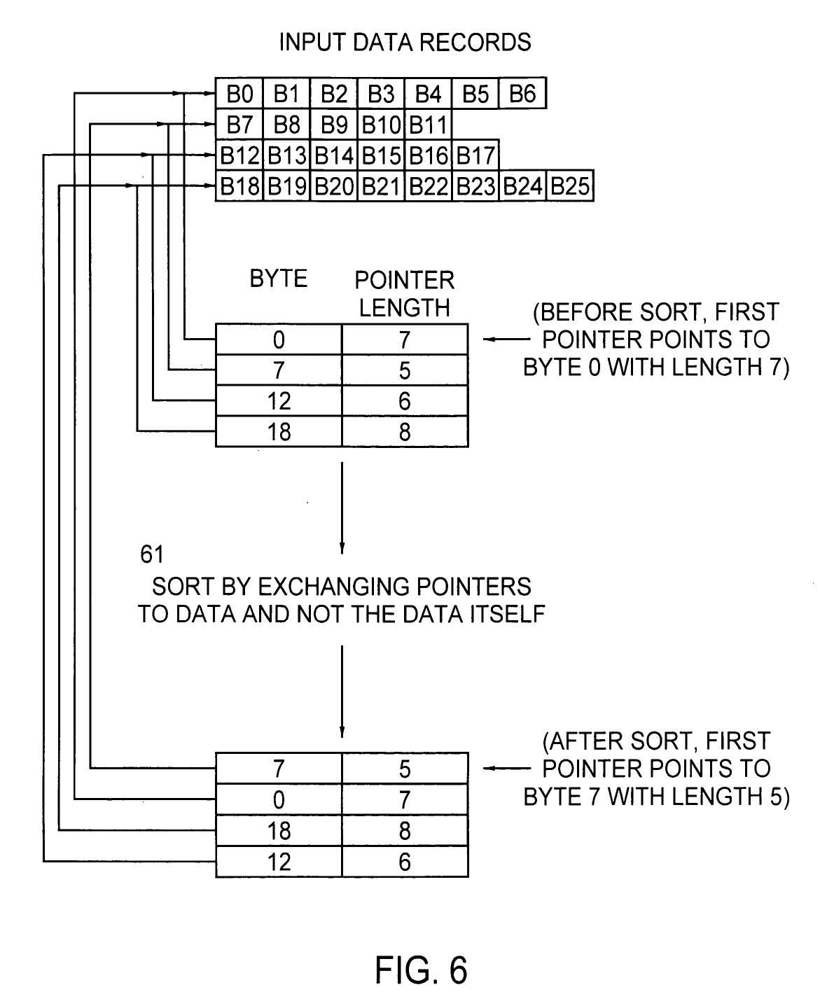

FIG. 6 is a diagram depicting input data records of varying length with representative keys used for comparison and exchange during the actual sort. A pointer array is built as the input data records are read with the pointers initially in numeric order, and each pointer pointing to a single data record. The pointer specifies the offset into the original file, and if the records are of varying length, then the length of each record may also be stored. For the varying length data shown in FIG. 6, the initial pointer array would have the first pointer point to character 100 with length 7, followed by second pointer to character 107 with length 5, followed by third pointer pointing to character 112 with length 6, followed by fourth pointer pointing to character 118 with length 8. After the sort, these pointers have been exchanged such that if they are accessed sequentially, they will point to the data in sorted order. The pointers are thus used to access the data from the input data array or file and write it in sorted order to an output file.

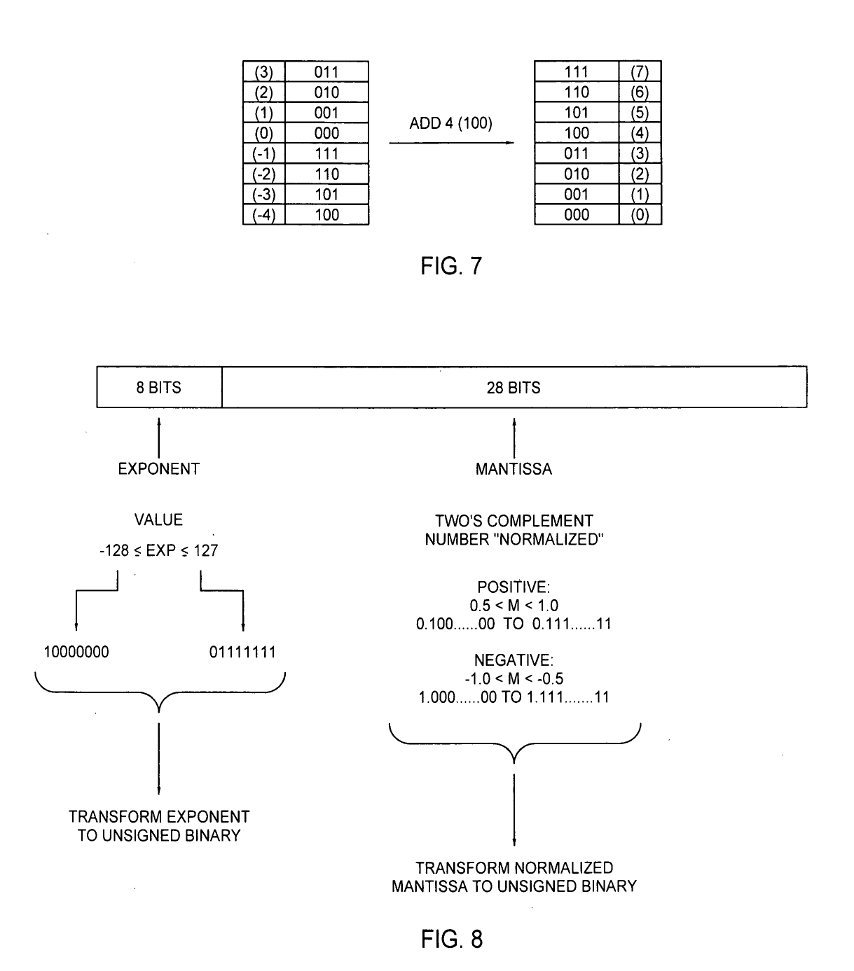

FIG. 7 is a diagram showing the transformation of signed numbers in two's complement form to unsigned strings of bits which can be directly compared as a part of the representative key for a data record. When a data field for a data record contains a signed number in two's complement form, this data cannot be used directly in a comparison in which the comparison is always made between strings of unsigned bits. The comparison used in the invention requires that the fields specified by the sort key be represented by representative keys which are an unsigned string of bits. In two's complement form a negative one is representing as a string of all one bits. With an unsigned comparison, this string of ones would always be larger than any other number which would be incorrect, because in reality a negative one is less than any positive number. Any two's complement number must thus be transformed into a representative string of bits in the representative key as shown in FIG. 7. The transformation algorithm is simply to consider the two's complement number as unsigned and add a number to it which has a value of a one followed by all zeroes, which in two's complement form would be the largest negative number. In FIG. 7 a three bit wide number is considered so this value is “4” which is one followed by two zeroes “100”. This addition of a constant “shifts” the range of two's complement numbers up such that an unsigned comparison can be made between any two numbers.

FIG. 8 is a diagram showing a second transformation to an unsigned string of bits for floating point numbers with both the exponent and the mantissa expressed in signed two's complement format. The transformation is to store the floating point number in “normalized” form. This method of storage results in a mantissa being in a fixed range of values such that the exponents can be used as a higher order comparison and the mantissa as a second order comparison only if the exponents are equal. This allows floating point data to be compared in a manner compatible with the word based comparison algorithm described above. The exponent and mantissa representations must be shifted to unsigned form as described for FIG. 7 such that the comparison will be between two “unsigned” numbers. The exponent is of higher significance than the mantissa as long as the mantissa is stored in normalized form.

Further consideration as to the effect of the ASCENDING or DESCENDING clause is also required. If any of the fields is specified as “DESCENDING”, then the number stored as representing the data must be negated in one's complement form so that the simple unsigned comparison of the two values will result in the opposite of what would have resulted if the specification were ASCENDING.

For decimal numeric data that has only a scale factor and no exponent, the numeric data can be packed into 4-bit fields with 16 digits per 64-bit word, and the scale factor can be disregarded because it is the same in both of the records to be compared.

For decimal numeric data with an exponent, or floating point data with an exponent, the data must be either transformed into a binary value which will hold the entire possible significance of the input data, or a special flag on the key must be maintained which causes the comparison routine to change its method of comparison for certain ranges of the key.

Similar transformations can be determined by one skilled in the art for any input data.

The method of the invention consists of a routine to take the sort order specification, and then apply it to each record as it is read from the file, and to store in memory, as a representative key, a string of bits representing the data such that a comparison of that string of bits as an unsigned comparison of two values will give the same result as comparing the two original keys with the same order of specification.

This string of bits in the representative key is essentially the same as the specified key data but in a different form. The data of the representative key is reordered from most significant to least significant as specified. The strings of bits representing each field of the key data are transformed as previously described into an unsigned string of bits which when used as part of any comparison will yield the desired comparison results.

It is also advantageous to start and end the string of bits making up the representative key on machine word boundaries such that the comparison of any two representative keys can be made using only word based comparisons. On a machine such as the Intel Itanium with a 64-bit machine word, the comparison of any two representative keys is made 64-bits at a time, and the comparison between any two keys can be halted as soon as the first difference between any two words is found.

It is also important to note that on most computing machines, including the Intel Itanium for which this methodology was first devised, the “word” based instructions and comparisons are much faster in execution and allow more pipeline overlap than the “character” based instructions. Aligning the data on word boundaries and structuring the preprocessing such that all comparisons of the representative keys can be done with word based instructions provides for ease of implementation and better performance because it eliminates the need for checking special conditions at the beginning and end of each record comparison.

What is claimed is:

1. A sorting process utilizing a computer system to sort a plurality of input data records and to produce an ordered set of output records comprising:
A) a first process component for obtaining input data records to be sorted;
B) a second process component for processing a plurality of input records, said second process component including:
1) an extraction of a sort field which is the portion of each data record which affects the order of the sort; and
2) further processing of the sort field to build a key record item representing each input data record with the key record being a string of bits which can be compared in order from most significant to least significant with resulting comparison of the keys giving the same comparative results as though comparing the original sort fields for any two data records.

2. The sorting process of claim 1 including also:
A) an alignment of said key data in computer system memory such that the bit fields for comparison start on a machine word boundary.

3. The sorting process of claim 1 including also:
A) an alignment of said key data in computer system memory such that the bit fields for comparison end on a machine word boundary.

4. The sorting process of claim 1 including also:
A) an alignment of said key data in computer system memory such that the bit fields for comparison start and end on a machine word boundary;
B) said alignment of key data including if necessary the adding of bits to the key data which pad the bits of the string enough to make its length be contained exactly in an integral number of machine words; and
C) a third process component for comparison of key data records utilizing machine instructions which compare whole unsigned machine words.

5. The sorting process of claim 1 including also:
A) a table of pointers in the computer system which point to the key data records; and
B) a fourth process component for exchanging pointers in the table of pointers with that exchange depending on comparison of the key data records.

6. The sorting process of claim 4 including also:
A) a table of pointers in the computer system which point to the key data records; and
B) a fifth process component for exchanging pointers in the table of pointers with that exchange depending on comparison of the key data records.

7. The sorting process of claim 6 including also:
A) a sixth process component for stepping through the table of pointers to the key records, obtaining the corresponding individual input data records and writing as output said input data records now in sorted order.
